(19) United States
(12) Patent Application Publication
(10) Pub. No.: US 2006/0096300 A1
(43) Pub. Date: May 11, 2006

(54) Water dispenser having thermoelectric cooling chips

(76) Inventors: Fred Reinstein, Beverly Hills, CA (US); Sacha Polakoff, Pacific Palisades, CA (US)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/259,252

(22) Filed: Oct. 27, 2005

Related U.S. Application Data
(60) Provisional application No. 60/622,011, filed on Oct. 27, 2004.

(51) Int. Cl. F25B 21/02; B67D 5/62

(52) U.S. Cl. 62/3.64; 62/389

(57) ABSTRACT

A water dispenser having a cold water tank maintaining water below room temperature. A thermoelectric chip module, preferably having two thermoelectric chips, extracts heat from the cold water tank. The cold side of the thermoelectric chip faces the cold water tank. The hot side of the thermoelectric chip has a heat sink or fans providing convection.

This application claims benefit of provisional application 60/622,011, filed Oct. 27, 2004.

### BACKGROUND OF THE INVENTION

Peltier devices, also known as thermoelectric (TE) modules, are small solid-state devices that function as heat pumps. A “typical” unit is a few millimeters thick by a few millimeters to a few centimeters square. It is a sandwich formed by two ceramic plates with an array of small Bismuth Telluride cubes (“couples”) in between. When a DC current is applied heat is moved from one side of the device to the other—where it must be removed with a heat sink. The “cold” side is commonly used to cool an electronic device such as a microprocessor or a photodetector. If the current is reversed the device makes an excellent heater.

As with any device, TE modules work best when applied properly. They are not meant to serve as room air conditioners. They are best suited to smaller cooling applications. They can be stacked to achieve lower temperatures, although reaching cryogenic temperatures would require great care. They are not very “efficient” and can draw amps of power. This disadvantage is more than offset by the advantages of no moving parts, no Freon or other refrigerant, no noise, no vibration, very small size, long life and capability of precision temperature control.

The cooling property of these devices is due to the Peltier Effect. Peltier Effect coolers are almost always constructed with Bismuth Telluride (Bi₂Te₃) and used around room temperature and below.

### SUMMARY OF THE INVENTION

A water dispenser having a cold water tank maintaining water below room temperature. A thermoelectric chip module, preferably having two thermoelectric chips, extracts heat from the cold water tank. The cold side of the thermoelectric chip faces the cold water tank. The hot side of the thermoelectric chip has a heat sink or fans providing convection.

### BRIEF DESCRIPTION OF THE DRAWINGS

FIG. 1 is an exploded view of the water dispenser; and

FIG. 2 is a perspective view of the cold water cooling system.

### DETAILED DESCRIPTION OF THE INVENTION

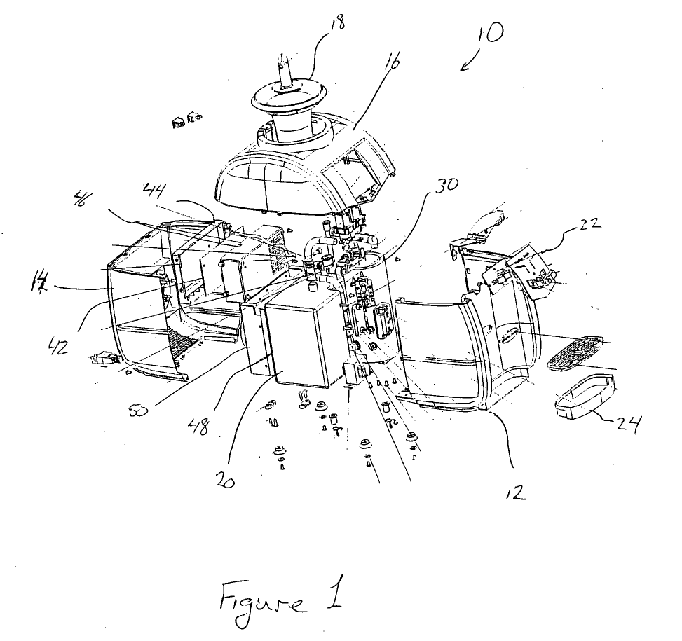

FIG. 1 shows an exploded view of the water dispenser having a front panel 12 a rear panel 14 and a top panel 16 together forming a housing for the water dispenser 10. The front panel 12 has dispensing controls 22 and a drip tray 24, as is conventional. The top panel has a bottle supporter 18. The hot and cold water tanks may be any size but 0.4 gallons for the cold water tank and 0.17 gallons for the hot water tank are standard.

Within the housing is a cold water tank 20 and hot water tank 30. These tanks are connected to dispensing openings in the housing by conventional means. The cold water tank maintains water below room temperature by a cooling system formed by a printed circuit board (PCB) 42 covered by a PCB cover 44. The PCB encased in the PCB housing 46. The housing 46 sits atop a thermoelectric chip module 48 and the PCB controls electrical flow to the thermoelectric chips. Preferably, the module contains two thermoelectric chips. The thermoelectric chip module 48 is provided with fans 50.

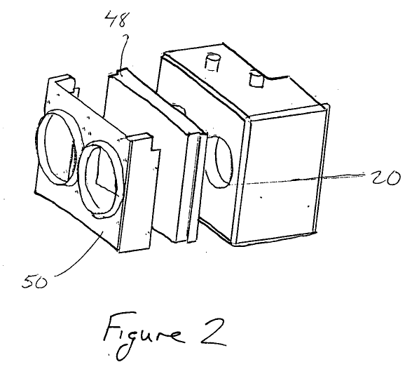

FIG. 2 shows the details of the cooling system for the cold water tank. Seen in FIG. 2 is the cold water tank 20 with the thermoelectric chip module 48 immediately adjacent the sidewall of the cold water tank 20. The cold side of the thermoelectric chip bears against and extracts heat from the cold water tank. Fans 50 are provided next to the thermoelectric chip module on the side opposite the cold water tank 20. The fans provide convection to remove excess heat from the hot side of the thermoelectric chips. Instead of a fan, any type of conventional heat sink may be used.

Alternative arrangements of the water dispenser are possible. The thermoelectric chip module can be positioned between and contacting both the hot water and cold water tanks. In this arrangement, the thermoelectric chip module extracts heat from the cold water tank and the hot water sink serves as a heat sink for the thermoelectric chip module. The hot water tank and cold water tank may each be provided with a secondary thermoelectric chip module to supplement the heating and cooling of the respective tanks to the desired temperatures, if necessary.

While the invention has been described with reference to the preferred embodiments, variations and modifications would be apparent to one of ordinary skill in the art. The invention encompasses such variations and modifications.

What is claimed is:

1. A water dispenser comprising
a housing,
a cold water tank within said housing,
at least one thermoelectric chip contacting said cold water tank.

2. The water dispenser of claim 1, further comprising
a printed circuit board controlling electricity to said at least one thermoelectric chip.

3. The water dispenser of claim 1, wherein
said at least one thermoelectric chip comprises two thermoelectric chips.

4. The water dispenser of claim 1, further comprising
a fan adjacent said at least one thermoelectric chip.

5. The water dispenser of claim 1, further comprising
a heat sink adjacent said at least one thermoelectric chip.

6. The water dispenser of claim 1, further comprising
a hot water tank with said housing.

7. The water dispenser of claim 6, wherein
said at least one thermoelectric chip contacts said hot water tank.
